(19) United States
(12) Patent Application Publication
(10) Pub. No.: US 2026/0312514 A1
(43) Pub. Date: Oct. 8, 2026

(54) ELECTRIC MACHINE ANGULAR POSITION OSCILLATION COMPENSATION

(71) Applicant: FORD GLOBAL TECHNOLOGIES, LLC, Dearborn, MI (US)

(72) Inventors: Yingfeng Ji, Northville, MI (US); Yue Nie, Ann Arbor, MI (US)

(21) Appl. No.: 19/171,927

(22) Filed: Apr. 7, 2025

(51) Int. Cl. H02P 6/16

(52) U.S. Cl. CPC H02P 6/16; H02P 2203/03

(57) ABSTRACT

A vehicle propulsion system comprises an electric machine including a shaft, a rotor mounted on the shaft, and a stator surrounding the rotor. The system further comprises a processor programmed to output a resolver speed signal that has an amplitude envelope that does not increase as runout of the shaft increases.

### TECHNICAL FIELD

Various embodiments relate to electric vehicles, and to dynamically compensating for rotor position offset of electric machines.

### BACKGROUND

Electric machines may incorporate synchronous motors having a stator and a rotor with permanent magnets. It may become necessary to determine a position of the rotor in order to meet electric motor control requirements. Various systems may use such electric machines including hybrid electric vehicles (HEV's), plug-in hybrid electric vehicles (PHEV's), and battery electric vehicles (BEV's) (hereinafter collectively referred to as “electric vehicles”). Electric vehicles may also be equipped with a battery that stores electrical power for powering the electric machines. In some electric vehicles, an electric machine may also be used as a generator that is powered by the internal combustion engine in order to generate electrical power to charge the battery.

### BRIEF DESCRIPTION OF THE DRAWINGS

FIG. 1 is a perspective view of an electric machine including a stator, a rotor, and a shaft.

FIG. 2 is a plot of rotor speed versus time.

FIG. 3A is plot of rotor position versus time.

FIG. 3B is a plot of rotor speed versus time.

FIG. 4A is plot of rotor misalignment versus time.

FIG. 4B is a plot of rotor speed versus time.

FIG. 4C is a plot of a rotor speed compensation signal versus time.

FIG. 5 is a flowchart of an algorithm for compensating raw resolver data.

### SUMMARY

A vehicle propulsion system includes an electric machine with a shaft-mounted rotor and a surrounding stator, along with a processor that outputs a resolver speed signal whose amplitude envelope remains stable as shaft runout increases. The processor may reduce the amplitude envelope relative to that of a raw resolver speed signal, which is derived from a current position parameter. To mitigate effects of misalignment caused by shaft runout, the processor generates a compensation parameter based on a gain and phase shift, and may update the gain according to the resolver speed signal's amplitude envelope. This compensation is then applied to the current position parameter associated with the rotor.

A method for processing rotor speed signals in an electric machine includes detecting when oscillations in a raw rotor speed signal exceed a threshold and, in response, compensating the signal to generate a corrected rotor speed signal. This corrected signal maintains an amplitude envelope that is lower than that of the raw signal, even as resolver misalignment changes. The compensation process involves generating a parameter based on a gain and phase shift associated with the rotor, applying this parameter to a current position value, and optionally updating the gain based on the amplitude envelope of the corrected signal. The raw rotor speed signal is derived from the same current position parameter.

A vehicle control system includes a processor that generates a corrected resolver speed signal from a raw resolver speed signal associated with an electric machine. The corrected signal has an amplitude envelope that remains lower than that of the raw signal and does not increase as resolver misalignment worsens. To achieve this, the processor generates a compensation parameter based on a gain and phase shift, which corrects for the misalignment. The processor may also update the gain based on the amplitude envelope of the corrected signal and apply the compensation parameter to a current position value associated with the machine's rotor.

### DETAILED DESCRIPTION

Detailed embodiments are provided below. These embodiments, however, are intended solely as examples and may take various alternative forms and configurations. The accompanying figures are not drawn to scale. Certain features may be exaggerated, minimized, or omitted to highlight specific details of particular components. Consequently, the structural and functional details described herein are not to be interpreted as limiting but rather as illustrative examples to guide those skilled in the art in applying the described concepts in different ways.

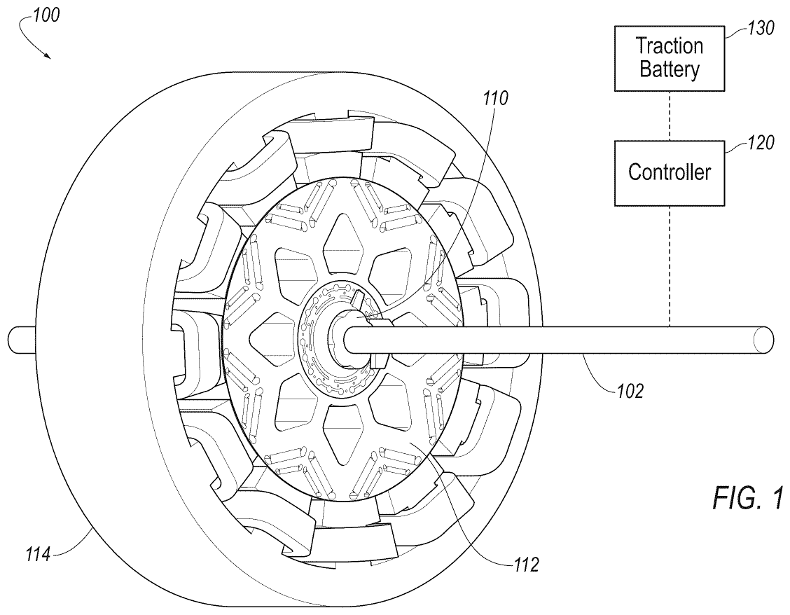

FIG. 1 depicts an example rotor position sensing system 100 for sensing electrical data including speed, position, and voltage of an electrical motor. The rotor position sensing system 100 can, for example, be incorporated into an electric vehicle or any electric motor system. The rotor position sensing system 100 determines rotor position of an electric machine (e.g., motor and/or generator). In one embodiment, the rotor position sensing system 100 includes a sensor 110 (or resolver 110), a controller 120, and a traction battery 130. The sensor 110 and controller 120 may draw electrical current from the traction battery 130 to power operations. The controller 120 may actuate systems such as the rotor position sensing system 100, the electric motor, etc. The electric machine may include a shaft 102 powered by the electric motor and configured to produce rotational torque. As an example, the shaft 102 may be included in an electric vehicle powertrain system.

The traction battery 130 stores energy that can be used by the electric machine. The traction battery 130 may provide a high voltage direct current (DC) output. A contactor module may include one or more contactors configured to isolate the traction battery 130 from a high-voltage bus when opened and connect the traction battery 130 to the high-voltage bus when closed. The high-voltage bus may include power and return conductors for carrying current over the high-voltage bus. The contactor module may be located in the traction battery 130. One or more power electronics modules may be electrically coupled to the high-voltage bus. The power electronics modules are also electrically coupled to the electric machine and provide the ability to bi-directionally transfer energy between the traction battery 130 and the electric machine. For example, the traction battery 130 may provide a DC voltage while the electric machine may operate with a three-phase alternating current (AC) to function. The power electronics module may convert the DC voltage to a three-phase AC current to operate the electric machine. In a regenerative mode, the power electronics module may convert the three-phase AC current from the electric machine acting as a generator to the DC voltage compatible with the traction battery 130.

The electric machine may be a permanent magnet synchronous motor (PMSM) type machine. A PMSM electric machine includes a rotor 112 and a stator 114. The stator 114 may include windings for producing a magnetic field to rotate the rotor. Current through the stator windings may be controlled to vary the magnetic field acting on the rotor 112. The rotor 112 includes permanent magnets that create a magnetic field that interacts with the stator magnetic field to cause rotation of the rotor 112. The rotor speed may be controlled by the frequency of the magnetic field created by the stator 114.

The rotor 112 may rotate about a central axis relative to the stator 114. The electric machine may be controlled by flowing a generally sinusoidal current through stator windings (e.g., wiring about teeth of the stator 114). The amplitude and frequency of the current may be varied by the controller 120 to control the torque and speed of the rotor 112. The stator 114 current creates an electromagnetic field that interacts with the permanent magnets that are part of the rotor 112. This electromagnetic field causes the rotor 112 to rotate. The electric machine may be configured as three-phase machines. That is, the stator windings may include three separate phase windings. To control the electric machine, a three-phase voltage or current waveform is applied to the phase windings. The three-phase waveform is such that each phase signal is separated by a phase difference of 120 degrees.

The sensor 110 may be a resolver, encoder, speed sensor, or other position sensor that is associated with the electric machine. In this embodiment, the sensor 110 is a resolver. The sensor 110 monitors angular position of the rotor 112 which is fixed to the shaft 102 of the electric machine. The sensor 110 communicates information to the controller 120, such as rotor position information concerning the rotor 112 and shaft 102.

Rotors and stators may experience misalignment. During assembly, the resolver rotor may be coupled to the electric motor shaft. A zero position of the resolver may be aligned with the expected rotor flux field of the rotor and the d-axis of the control field. For example, the rotor may include a cutout that corresponds to the rotor flux field. The shaft may include a notch configured to mate with the cutout in the rotor to provide an initial alignment between the resolver value and the rotor flux field. The desired alignment may be such that at an angle of zero, the motor U-phase is aligned with the center of the resolver sine winding. In addition, the resolver may be mounted in a fixed manner relative to the stator such that the rotor flux field is aligned with the d-axis. This may provide an initial estimate of the rotor flux field position and the d-axis. However, due to various conditions including manufacturing and assembly tolerances, shaft runout may increase over prolonged usage, etc. Due to this, the d-axis and the rotor flux field may not be aligned and the resolver value for alignment may not be known precisely. In configurations in which there are no physical alignment devices, a method of learning the alignment may be used to manage control. For example, a resolver value corresponding to an offset angle between the rotating frame and the stationary frame can be learned. This relationship may be expressed as a resolver offset. For example, an offset added to the resolver angle may yield the correct resolver value at which the rotor flux field and the d-axis of the rotating reference frame are aligned. Once identified, the resolver offset may be stored in non-volatile memory for continued use.

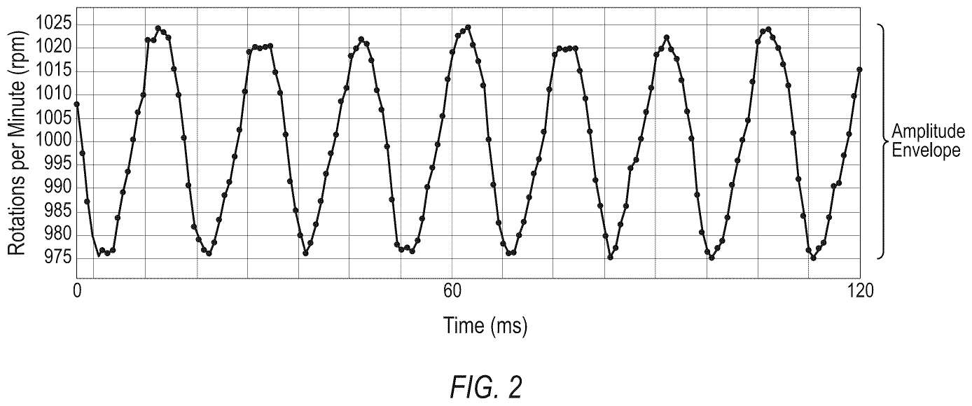

FIG. 2 illustrates waveform data produced by a misaligned resolver. The controller 120 may receive the data from the resolver prior to applying any compensation (e.g., raw data). Particularly, the speed oscillation may result from any fault which causes misalignment such as faulty manufacturing, eccentricity, shaft runout, etc. The waveform may have an amplitude envelope. The amplitude envelope is the amplitude limit of the waveform. The controller 120 may store a specified amplitude envelope to be achieved after applying compensation. In this example, the rotations per minute indicated by the resolver are oscillating within an amplitude envelope prior to compensation, and the amplitude envelope is greater than a specified envelope. Misalignment may manifest or increase in a resolver over time due to wear. The controller 120 may dynamically add an offset to the resolver angle to yield the correct resolver value at which the rotor flux field and the d-axis of the rotating reference frame are aligned. That is, the controller 120 may compensate or correct the raw resolver data. The controller 120 may apply a stored algorithm including a plurality of equations to compensate the raw data. For example, the algorithm may include the following equations:

$$θ = f ( A , B , Z ) \qquad Equation 1$$

The controller 120 may receive the A, B, Z discrete signals from the incremental decoder on the control board. The position is calculated based on the 24-bit counter as shown in Equation 1.

$${θ}_{comp} = G * sin ( n θ + φ ) \qquad Equation 2$$

The controller 120 may use Equation 2 to calculate the specific compensation position to be applied to the raw data (e.g., the waveform data depicted data from a misaligned resolver). G is the gain of the system based on the rotational speed of the rotor 112. φ is the phase shift. n is the order of the compensated signal referring to the position sensing fundamental harmonics.

$${θ}_{c u r rent} = θ + {θ}_{comp} \qquad Equation 3$$

As per Equation 3, the controller 120 may add the compensation position calculated by Equation 2 to the raw positional data. The compensation position cancels the first-order harmonic component caused by the misalignment.

$$Δ θ = {θ}_{c u r rent} - {θ}_{last} \qquad Equation 4$$

$${ω}_{e} = \frac{Δθ}{Δ t} \qquad Equation 5$$

The controller 120 may use Equation 4 to calculate the positional difference between the raw data and the compensated data as well as calculate the speed of the rotor 112 using Equation 5, in which Δt is the loop rate.

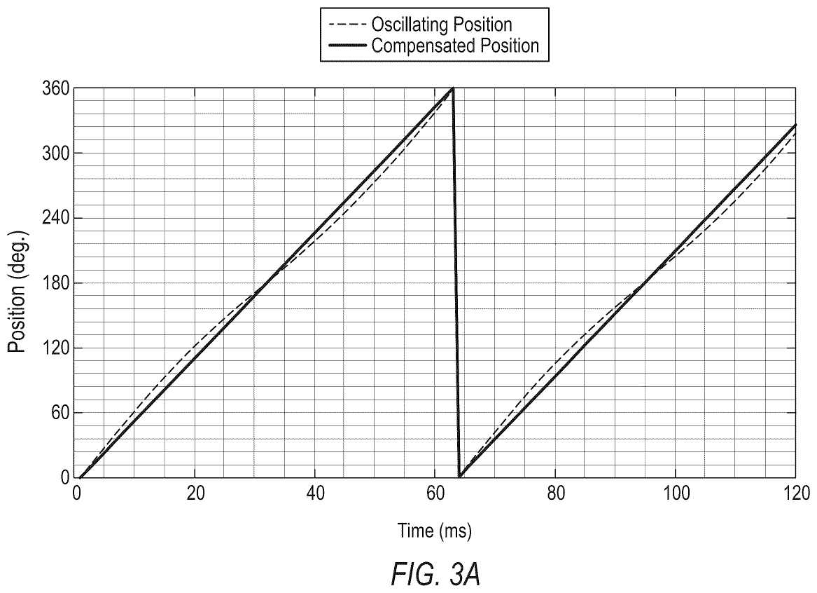

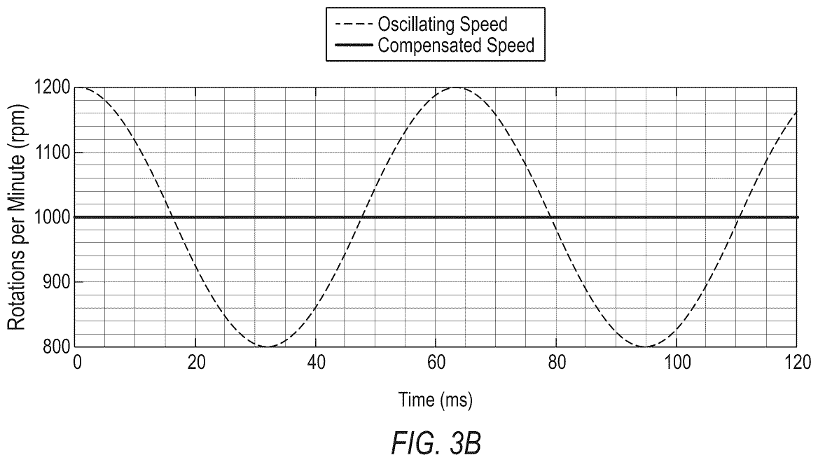

FIG. 3A shows simulated positions in two electric cycles. The dotted line represents the resolver position prior to compensation (e.g., raw data) and the solid line represents the resolver position data after compensation. The X axis is time measured in milliseconds and the Y axis is the oscillation position. FIG. 3B shows simulated speeds of the rotor 112 as detected by the resolver. The X axis is time measured in milliseconds and the Y axis is rotations per minute (rpm) of the rotor. The dotted line represents the resolver position prior to compensation (e.g., raw data) and the solid line represents the resolver position after compensation.

The algorithms contemplated herein, which may include Equations 1-5, compensate the raw data as misalignment changes. For example, increases in shaft runout may alter alignment of the resolver over time with continued operation of the electric machine. The controller 120 may use the algorithm described above to compensate the raw data and output the corrected data to yield a corrected resolver value at which the rotor flux field and the d-axis of the rotating reference frame are aligned despite changing alignment over time. For example, the controller 120 may apply the algorithm to raw resolver data received from a resolver having a specified misalignment to output corrected data and, in a scenario where misalignment is increased or decreased, the controller 120 may continue to output the corrected data despite the changing measurement conditions.

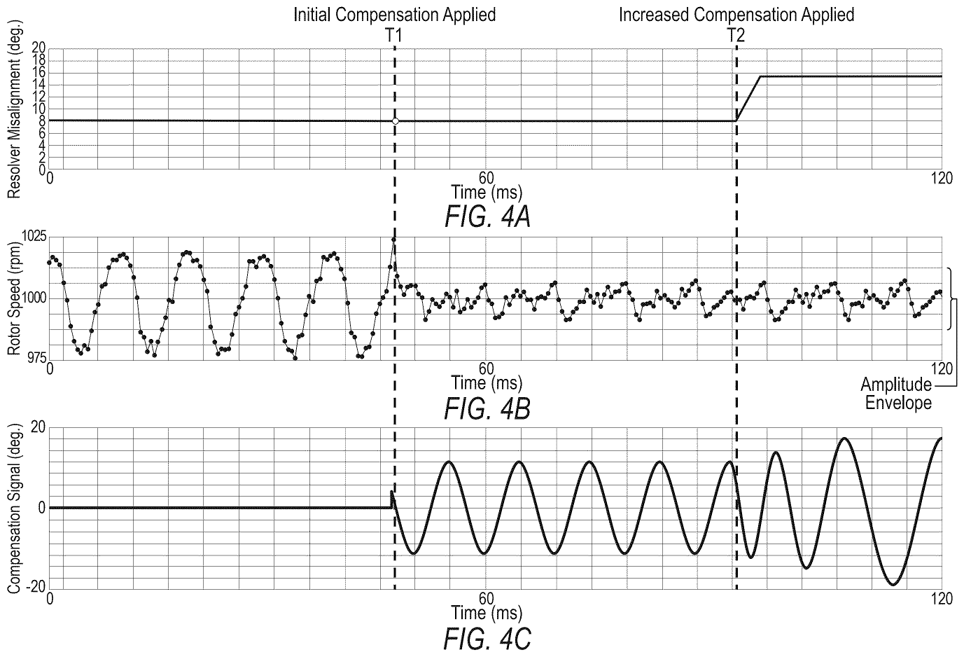

FIGS. 4A-4C illustrate waveform data before and after the controller 120 has applied the compensation algorithm to output corrected data. The gain applied to the resolver is not shown. In this example, the optimal gain is −20 based on a rotor speed of 1000 rpm. However, the controller 120 may apply different gains for different rotor 112 speeds. For example, the controller 120 may store a plurality of lookup table values specifying gains based on speed. FIG. 4A shows the misalignment of the resolver. The misalignment remains constant through time T1 up until time T2, where it increases. FIG. 4B shows speed data of the rotor as output by the controller 120. The amplitude of the oscillating speed decreases at time T1 after the controller 120 applies the compensation algorithm and is therefore brough within the specified amplitude envelope. The controller 120 does not necessarily eliminate speed oscillation via the compensation algorithm but rather decreases the amplitude of speed oscillation to be within the specified amplitude envelope. The amplitude of the speed oscillation remains within the envelope after T2 even though the misalignment has increased. FIG. 4C shows the compensation signal as calculated by the controller 120 using the compensation algorithm. Prior to the controller 120 applying compensation at time T1, the waveform is flat representing the absence of compensation. The waveform becomes sinusoidal once the calculated compensation from Equation 2 is applied. At time T2, the amplitude of the compensation signal increases to further compensate for the increased misalignment allowing the speed oscillation to remain within the envelope between T1 and T2.

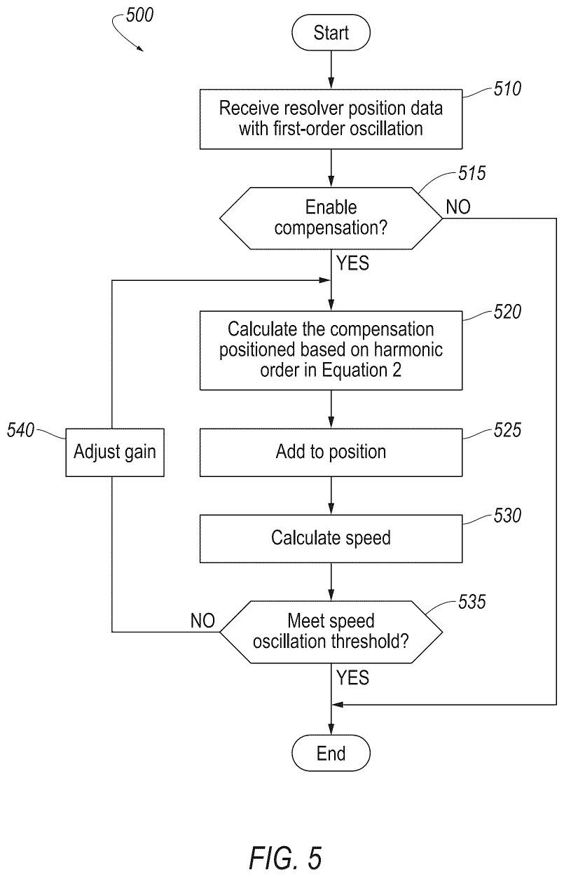

FIG. 5 is a flowchart illustrating an example process 500 for compensating raw resolver data. A computer such as the controller 120 may store executable instructions for performing the steps of the process 500 and/or programming can be implemented in structures such as those mentioned above. The process 500 may continue for as long as the electric machine remains on.

The process begins in block 510 in which the controller 120 receives raw data from the resolver. The resolver at this stage may be misaligned or properly aligned as described above.

In block 515, the controller 120 determines whether to enable compensation. The controller 120 may enable compensation based on the amplitude of the raw speed waveform exceeding a threshold amplitude. For example, the threshold amplitude for a system designed to run at 1000 rpm may be 40 rpm. Therefore, if the amplitude of the speed waveform oscillates beyond 960 rpm and 1040 rpm, the controller 120 may enable compensation. If the controller determines that the speed of the resolver is oscillating outside the specified threshold, the process 500 continues to block 520. Otherwise, the process 500 ends.

In block 520, the controller 120 has determined to apply compensation to the raw resolver data. The controller 120 then applies Equation 2 of the compensation algorithm to determine the compensation position.

In block 525, the controller 120 applies Equation 4 to the compensation position determined in block 520 in order to determine the corrected position of the resolver as described above.

In block 530, the controller 120 applies Equation 5 to determine the corrected speed of the resolver as described above.

In block 535, the controller 120 determines whether the adjustments made based on the compensation algorithm have decreased the amplitude of the speed waveform to within the threshold oscillation described above. If the speed oscillation is within the specified threshold the process 500 ends. Otherwise, the process 500 continues to block 540.

In block 540, the controller 120 has determined that the adjustments made to the raw data have not reduced the speed amplitude sufficiently to bring the speed waveform within the specified oscillation threshold. The controller 120 then adjusts the gain of the system and continues to the block 520 to repeat the compensation algorithm. The controller 120 may adjust the gain by a specified amount stored, for example, in a plurality of lookup table values.

Computing devices such as those discussed herein generally include commands executable by one or more computing devices such as those identified above, and carry out blocks or steps of processes described above. For example, process blocks discussed above may be embodied as computer executable commands.

Computer executable commands may be compiled or interpreted from computer programs created using a variety of programming languages or technologies, including, without limitation, and either alone or in combination, Java™, C, C++, Python, Julia, SCALA, Visual Basic, Java Script, Perl, HTML, etc. In general, a processor (e.g., a microprocessor) receives commands (e.g., from a memory, a computer readable medium, etc.) and executes these commands, thereby performing one or more processes, including one or more of the processes described herein. Such commands and other data may be stored in files and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (e.g., instructions) that may be read by a computer. Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, PROM, EPROM, FLASH-EEPROM, any other memory chip or cartridge, or any other medium from which a computer can read.

Although the steps or blocks of processes, etc. have been described as occurring according to a certain ordered sequence, such processes could be practiced with the described steps performed in an order other than the order described. Certain steps could be performed simultaneously, other steps could be added, or certain steps described herein could be omitted.

While example embodiments have been described above, they are not intended to represent an exhaustive list of all possible implementations. The language used in the specification is intended to describe, not to limit, and it is understood that various modifications may be made without departing from the broader scope and underlying principles of the disclosed subject matter. The terms “processor” and “processors,” for example, can be used interchangeably herein. Additionally, features from different embodiments may be combined to create further variations within the scope of the claims.

What is claimed is:

1. A vehicle propulsion system comprising:
an electric machine including a shaft, a rotor mounted on the shaft, and a stator surrounding the rotor; and
a processor programmed to output a resolver speed signal that has an amplitude envelope that does not increase as runout of the shaft increases.

2. The system of claim 1, wherein the processor is further programmed to output the resolver speed signal such that the amplitude envelope is less than an amplitude envelope of a raw resolver speed signal.

3. The system of claim 2, wherein the raw resolver speed signal is based on a current position parameter.

4. The system of claim 1, wherein the processor is further programmed to generate a compensation parameter associated with the rotor that is a function of a gain and a phase shift and that corrects for misalignment due the runout.

5. The system of claim 4, wherein the processor is further programmed to update a value of the gain based on the amplitude envelope of the resolver speed signal.

6. The system of claim 4, wherein the processor is further programmed to apply the compensation parameter to a current position parameter associated with the rotor.

7. A method comprising:
responsive to oscillation of a raw rotor speed signal of an electric machine exceeding a value, compensating the raw rotor speed signal to produce a corrected rotor speed signal that continues to have an amplitude envelope less than an amplitude envelope of the raw rotor speed signal as misalignment associated with a resolver of the electric machine changes.

8. The method of claim 7, wherein the compensating further produces the corrected rotor speed signal such that the amplitude envelope of the corrected rotor speed signal does not change as the misalignment increases.

9. The method of claim 7, wherein the compensating includes generating a compensation parameter associated with a rotor of the electric machine that is a function of a gain and a phase shift.

10. The method of claim 9 further comprising updating a value of the gain based on the amplitude envelope of the corrected rotor speed signal.

11. The method of claim 9, wherein the compensating includes applying the compensation parameter to a current position parameter associated with the rotor.

12. The method of claim 11, wherein the raw rotor speed signal is based on the current position parameter.

13. A vehicle control system comprising:
a processor programmed to output a corrected resolver speed signal that corresponds to a raw resolver speed signal associated with an electric machine such that an amplitude envelope of the corrected resolver speed signal is less than an amplitude envelope of the raw resolver speed signal and does not increase as resolver misalignment associated with the electric machine increases.

14. The system of claim 13, wherein the processor is further programmed to generate a compensation parameter that is a function of a gain and a phase shift and that corrects for the resolver misalignment.

15. The system of claim 14, wherein the processor is further programmed to update a value of the gain based on the amplitude envelope of the corrected resolved speed signal.

16. The system of claim 14, wherein the processor is further programmed to apply the compensation parameter to a current position parameter associated with a rotor of the electric machine.
